(19) United States
(12) Patent Application Publication
(10) Pub. No.: US 2011/0297286 A1
(43) Pub. Date: Dec. 8, 2011

(54) Tire for Heavy Vehicles Having a Crown Reinforcement Comprising a Complex Strip

(75) Inventor: Michael Cogne, Riom (FR)

(73) Assignees: Michelin Recherche et Technique S.A., Granges-Paccot (CH); SOCIETE DE TECHNOLOGIE MICHELIN, Clemont-Ferrand (FR)

(21) Appl. No.: 13/061,880

(22) PCT Filed: Sep. 1, 2009
(86) PCT No.: PCT/EP09/61288

§ 371 Date: May 24, 2011

(30) Foreign Application Priority Data
Sep. 2, 2008 (FR) 0855887

(51) Int. Cl. B60C 9/00; B60C 5/00

(52) U.S. Cl. 152/451

(57) ABSTRACT

A tire comprising a crown reinforcement formed of at least two working crown layers of reinforcing elements itself radially capped by a tread strip, the tread strip being connected to two beads via two sidewalls. At least two working crown layers are formed by circumferential winding of a complex strip formed of two layers including continuous reinforcing elements passing from one layer to the other, the said reinforcing elements being parallel within a layer and crossed from one layer to the other at angles with respect to the circumferential direction that are identical in terms of absolute value.

The present invention relates to a tire with a radial carcass reinforcement anchored on each side to at least one bead wire and having a crown reinforcement consisting of at least two layers known as working layers which are superposed and formed of reinforcing elements that are parallel within each layer and crossed from one layer to the next making an angle with the circumferential direction of the tire.

Tires comprising such working layers have, in certain uses, endurance performance which is limited due to the very presence of these working layers.

The problem is that there are stresses in the crown reinforcement and more particularly, shear stresses between the crown layers, which, when combined with a not-insignificant increase in the operating temperature at the ends of the said layers, lead to the appearance and spread of cracks in the rubber at the said ends. The same problem exists in the case of edges of two layers with reinforcing elements, the said other layer not necessarily having to be radially adjacent to the first.

In order to improve the endurance of the crown reinforcement of such tires, solutions relating to the structure and quality of the layers and/or profiles of rubber compounds positioned between and/or around the ends of the layers have been put into effect. However, these solutions have reached their limits in the case of certain specific uses. Other solutions too have been put into effect in the case of specific uses.

Although not limited to this type of application, the invention will be more specifically described with reference to tires for airplanes and tires for metro rolling stock.

In terms of airplane tires, the crown reinforcement usually consists of multiple layers including the layers known as the working layers, which are superposed and formed of reinforcing elements that are parallel within each layer and crossed from one layer to the next.

These layers are usually produced using techniques that involve laying reinforcing elements or tapes consisting of several reinforcing elements, running from one edge to the other continuously to form a period or a multiple of periods for one revolution of the wheel. Using these techniques, it is thus possible to produce working layers formed of reinforcing elements that are parallel in each layer and cross from one layer to the next and which have no free ends at the edges of the plies and therefore improve the endurance of the tires.

However, these operating techniques do result in relatively lengthy manufacturing times and therefore to a relatively high tire cost.

In terms of tires for metro vehicles, the current crown reinforcement of these tires essentially consists of a circumferential winding of a tape of circumferential reinforcing elements. The reinforcing elements are usually made of aramid. It is known that such tires may exhibit uneven wear in the shoulder region of the tire. Conceivable solutions for improving the wear properties of these tires might involve adding working layers of reinforcing elements that are parallel in each layer and cross from one layer to the next. However, working layers with free ends of reinforcing elements at the edge of the layers would detract from the endurance performance of the tire. Working layers produced using the technique described hereinabove for the case of airplane tires would lead to high costs of manufacture for this type of tire.

Cords are said to be inextensible when the said cords exhibit a relative elongation of at most 0.2% under a tensile force equal to 10% of the breaking strength.

Cords are said to be elastic when the said cords exhibit a relative elongation of at least 4% under a tensile force equal to the breaking strength.

The circumferential direction of the tire, or longitudinal direction, is the direction corresponding to the periphery of the tire and defined by the direction in which the tire runs. Circumferential reinforcing elements are elements which make angles contained in the range +2.5°,−2.5° about 0° to the said direction.

The transverse or axial direction of the tire is parallel to the axis of rotation of the tire.

The radial direction is the direction that intersects the axis of rotation of the tire and is perpendicular thereto. Substantially radial reinforcing elements are elements which make angles contained in the range +5°,−5° about 0° to the meridian direction.

The axis of rotation of the tire is the axis about which it rotates under normal use.

A radial or meridian plane is a plane which contains the axis of rotation of the tire.

The circumferential mid-plane or equatorial plane is a plane perpendicular to the axis of rotation of the tire and which divides the tire into two halves.

The inventors have set themselves the task of providing tires for heavy vehicles, the endurance performance of which is improved over the conventional tires or in which the compromise between endurance performance and cost of manufacture is improved.

This objective is achieved according to the invention by a tire comprising a crown reinforcement formed of at least two working crown layers of reinforcing elements, itself radially capped by a tread strip, the said tread strip being connected to two beads via two sidewalls, at least two working crown layers being formed by circumferential winding of a complex strip formed of two layers consisting of continuous reinforcing elements passing from one layer to the other, the said reinforcing elements being parallel within a layer and crossed from one layer to the other at angles with respect to the circumferential direction that are identical in terms of absolute value.

The tire thus produced according to the invention comprises layers of reinforcing elements that are parallel within a layer and crossed from one layer to the other, which have no ends on their edges and which are relatively simple to implement; what happens is that two layers are produced simultaneously by circumferential winding of a prefabricated element that the complex strip constitutes. Circumferential winding is in fact a relatively simple technique to perform and which can be carried out at high speed; further, as recalled hereinabove, at least two layers are produced simultaneously.

A circumferential winding corresponds to a winding of the complex strip in such a way that the turns formed make an angle of less than 8° with the circumferential direction.

According to one preferred embodiment of the invention, the radial distance between the respective reinforcing elements of each of the crown layers forming a complex strip is less than the thickness of a crown layer and preferably less than half the thickness of a crown layer.

Within the meaning of the invention, the radial distance between the respective reinforcing elements of each of the crown layers is measured radially between the respectively upper and lower generatrices of the said reinforcing elements of the radially inner and radially outer crown layers. The thickness of the crown layer is also measured in the radial direction.

Preferably also, with each of the layers being formed of reinforcing elements between two liners made of polymer compounds each forming a thickness radially on the outside and radially on the inside of the said reinforcing elements, the radial distance between the respective reinforcing elements of each of the crown layers is substantially equivalent to the sum of the thickness of polymer compound in the liner radially on the outside of the reinforcing elements of the radially inner crown layer and of the thickness of polymer compound in the liner radially on the inside of the reinforcing elements of the radially outer crown layer.

The complex strip may be obtained in advance using a method that involves flattening a tube, itself formed by winding, in contiguous turns at a given angle with respect to the longitudinal direction of the tube, a tape in which reinforcing elements are parallel to one another and to the longitudinal direction of the said tape and coated in a polymer compound. The width of the tape is adjusted to suit the angle at which the turns are wound, to make the turns contiguous.

When the said tube is flattened, because the turns are perfectly contiguous, the complex strip obtained consists of two layers of continuous reinforcing elements passing from one layer to the other, the said reinforcing elements being parallel in one layer and crossed from one layer to the other at angles with respect to the circumferential direction that are identical in terms of absolute value. Producing a tube with contiguous turns makes it possible to obtain linear reinforcing elements in each of the layers, with the exception of the axial ends of each of the layers, where the reinforcing elements form loops to ensure the continuity between one layer and the next.

This linearity of the reinforcing elements in each of the layers allows constant longitudinal rigidity and constant shear rigidity to be conferred upon the entire width of the said layers that form the complex strip.

The flattening of the said tube also makes it possible to obtain coupling between the layers so that the radial distance between the respective reinforcing elements of each of the layers is substantially equivalent to the sum of the thickness of polymer compound in the liner radially on the outside of the reinforcing elements of the radially inner layer and of the thickness of polymer compound in the liner radially on the inside of the reinforcing elements of the radially outer layer, the said liners coming into contact with one another.

Such coupling between the two crown layers encourages high longitudinal rigidity and high shear rigidity. An indirect consequence of this is that the tire becomes lighter as it would require several layers of complex strip if the layers of which these strips were formed were not sufficiently coupled so that the desired longitudinal and shear rigidities could be obtained.

According to one particularly advantageous embodiment, the reinforcing elements of the said complex strip make an angle of between 10 and 45° with the circumferential direction.

As explained previously, the angle formed by the reinforcing elements with the circumferential direction corresponds to the angle that the turns of the tube make with the longitudinal direction of the tube before this tube is flattened. Small angles may make the complex strip easier to produce using the method as described hereinabove.

According to a first alternative form of embodiment, the complex strip is wound circumferentially with an axial overlap, preferably equal to at least half the width of the said complex strip. Axial overlap makes it possible to avoid the creation of regions in which the presence of reinforcing elements is not as great. Having an axial overlap of at least half the width of the complex strip makes it possible to produce simultaneously four working layers the reinforcing elements of which are crossed from one layer to the next, the angles of the reinforcing elements being identical in terms of absolute value in each of the layers.

When producing an airplane tire, an axial overlap at least equal to two-thirds of the width of the complex strip may allow at least six working layers to be produced simultaneously.

According to another alternative form of embodiment of the invention, the complex strip is wound circumferentially to form juxtaposed turns. Such an alternative form of embodiment allows two working layers to be created without creating any excess thickness.

According to a first embodiment of the invention, the reinforcing elements of the complex strip are made of metal.

Advantageously, according to this first embodiment of the invention, the reinforcing elements of the complex strip are metal reinforcing elements having a secant modulus at 0.7% elongation of between 10 and 120 GPa and a maximum tangent modulus of less than 150 GPa.

According to a preferred embodiment, the secant modulus of the reinforcing elements at 0.7% elongation is less than 100 GPa and greater than 20 GPa, preferably is comprised between 30 and 90 GPa and more preferably still is less than 80 GPa.

For preference also, the maximum tangent modulus of the reinforcing elements is less than 130 GPa and more preferably still, less than 120 GPa.

The modulus values expressed hereinabove are measured on a curve of tensile stress as a function of elongation determined with a preload of 20 MPa divided by the cross section of metal in the reinforcing element, the tensile stress corresponding to a measured tension divided by the cross section of metal in the reinforcing element.

The modulus values for the same reinforcing elements can be measured on a curve of tensile stress as a function of elongation determined with a preload of 10 MPa divided by the overall cross section of the reinforcing element, the tensile stress corresponding to a measured tension divided by the overall cross section of the reinforcing element. The overall cross section of the reinforcing element is the cross section of a composite reinforcing element made of metal and rubber, the latter having notably penetrated the reinforcing element during the tire curing phase.

According to this formulation relating to the overall cross section of the reinforcing element, the reinforcing elements of the complex strip are metal reinforcing elements having a secant modulus of between 5 and 60 GPa at 0.7% elongation and a maximum tangent modulus of less than 75 GPa.

According to a preferred embodiment, the secant modulus of the reinforcing elements at 0.7% elongation is less than 50 GPa and greater than 10 GPa, preferably is comprised between 15 and 45 GPa and more preferably still is less than 40 GPa.

For preference also, the maximum tangent modulus of the reinforcing elements is less than 65 GPa and more preferably still, less than 60 GPa.

According to a preferred embodiment, the reinforcing elements of the complex strip are metal reinforcing elements having a curve of tensile stress as a function of relative elongation that exhibits shallow gradients for small elongations and a substantially constant and steep gradient for higher elongations. Such reinforcing elements in the additional ply are generally known as “bi-modulus” elements.

According to a preferred embodiment of the invention, the substantially constant and steep gradient appears starting from a relative elongation of between 0.1% and 0.5%.

The various characteristics of the reinforcing elements as mentioned hereinabove are measured on reinforcing elements taken from tires.

Reinforcing elements more particularly suited to producing the complex strip according to the invention are, for example, assemblies of formula 21.23, the construction of which is 3×(0.26+6×0.23) 4.4/6.6 SS; this stranded cord consists of 21 elementary threads of formula 3×(1+6), with 3 strands twisted together, each consisting of 7 threads, one thread forming a central core with a diameter equal to 26/100 mm and 6 wound threads with a diameter equal to 23/100 mm. Such a cord has a secant modulus equal to 45 GPa at 0.7% and a maximum tangent modulus equal to 98 GPa, measured on a curve of tensile stress as a function of elongation determined with a preload of 20 MPa divided by the cross section of metal in the reinforcing element, the tensile stress corresponding to a measured tension divided by the cross section of metal in the reinforcing element. On a curve of tensile stress as a function of elongation determined with a preload of 10 MPa divided by the overall cross section of the reinforcing element, the tensile stress corresponding to a measured tension divided by the overall cross section of the reinforcing element, this cord of formula 21.23 has a secant modulus equal to 23 GPa at 0.7% and a maximum tangent modulus equal to 49 GPa.

Likewise, another example of reinforcing elements is an assembly of formula 21.28, the construction of which is 3×(0.32+6×0.28) 6.2/9.3 SS. This cord has a secant modulus equal to 56 GPa at 0.7% and a maximum tangent modulus equal to 102 GPa, measured on a curve of tensile stress as a function of elongation determined with a preload of 20 MPa divided by the cross section of metal in the reinforcing element, the tensile stress corresponding to a measured tension divided by the cross section of metal in the reinforcing element. On a curve of tensile stress as a function of elongation determined with a preload of 10 MPa divided by the overall cross section of the reinforcing element, the tensile stress corresponding to a measured tension divided by the overall cross section of the reinforcing element, this cord of formula 21.28 has a secant modulus equal to 27 GPa at 0.7% and a maximum tangent modulus equal to 49 GPa.

The use of such reinforcing elements in the complex strip notably makes it possible to produce the tube and to flatten the said tube simply using the method described hereinabove, at the same time limiting the risks of the reinforcing elements breaking and improving the ability of the complex strip to remain flat after it has been produced, notably when the angle formed between the circumferential direction and the reinforcing elements of the two working crown layers is greater than 40°.

The metal elements are preferably steel cords.

According to a second embodiment of the invention, the reinforcing elements of the complex strip are made of a textile material such as materials of nylon, aramid, PET, rayon, polyketone type.

According to a third embodiment of the invention, the reinforcing elements of the complex strip are made of a hybrid material. These may be textile hybrid materials such as reinforcing elements consisting of aramid and of nylon like those described in document WO 02/085646 or alternatively may be hybrid materials combining textile materials and metallic materials.

Some embodiments of the invention make provision for the crown reinforcement to comprise at least one layer of circumferential reinforcing elements. Particularly in the case of a tire for metro rolling stock as discussed previously, the complex strip will be set in position radially on the outside of the layer of circumferential reinforcing elements.

According to other forms of embodiment of the invention, the crown reinforcement may be further supplemented radially on the outside by at least one supplementary layer, known as a protective layer, of reinforcing elements know as elastic elements, oriented with respect to the circumferential direction at an angle of between 10° and 45° and in the same direction as the angle formed by the elements of the complex strip radially adjacent to it.

Advantageously also according to the invention, the angle formed with the circumferential direction by the reinforcing elements of the complex strip is smaller than 30° and preferably smaller than 25°, notably when a layer of circumferential reinforcing elements is present in order to reduce the tensile stresses acting on the axially outermost circumferential elements.

According to any one of the embodiments of the invention mentioned hereinabove, the crown reinforcement may be further supplemented radially on the inside between the carcass reinforcement and the radially inner working layer that is closest to the said carcass reinforcement, by a triangulation layer of metal inextensible reinforcing elements made of steel which make an angle that is greater than 60° with the circumferential direction, and that is in the same direction as the angle formed by the reinforcing elements of the layer radially closest to the carcass reinforcement.

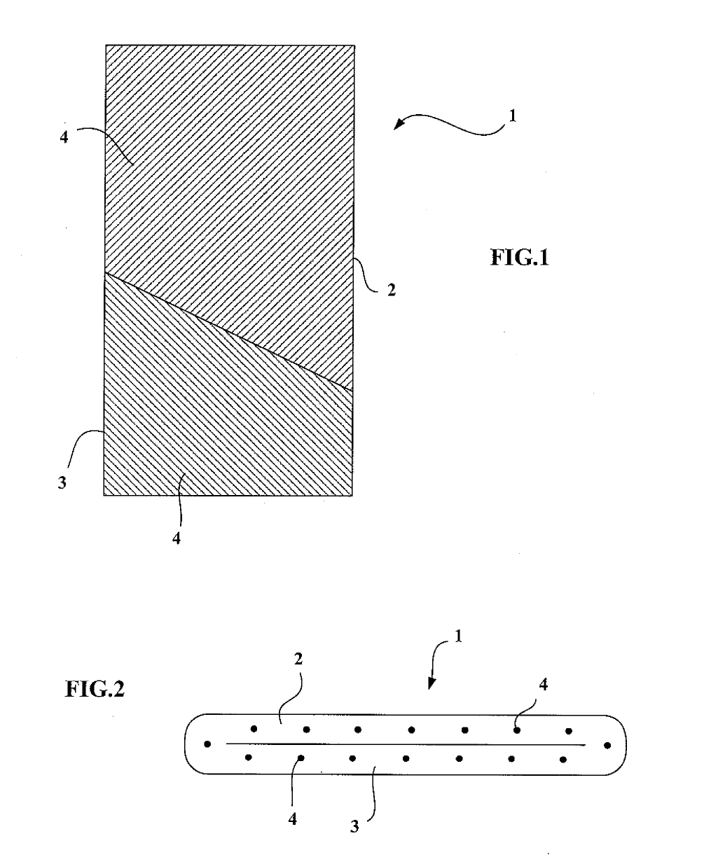

Further details and advantageous features of the invention will become apparent hereinafter from the description of some exemplary embodiments of the invention with reference to FIGS. 1 to 3 which depict:

FIG. 1: a perspective view, with cutaway, of a complex strip according to the invention;

FIG. 2: a meridian view of the complex strip of FIG. 1; and

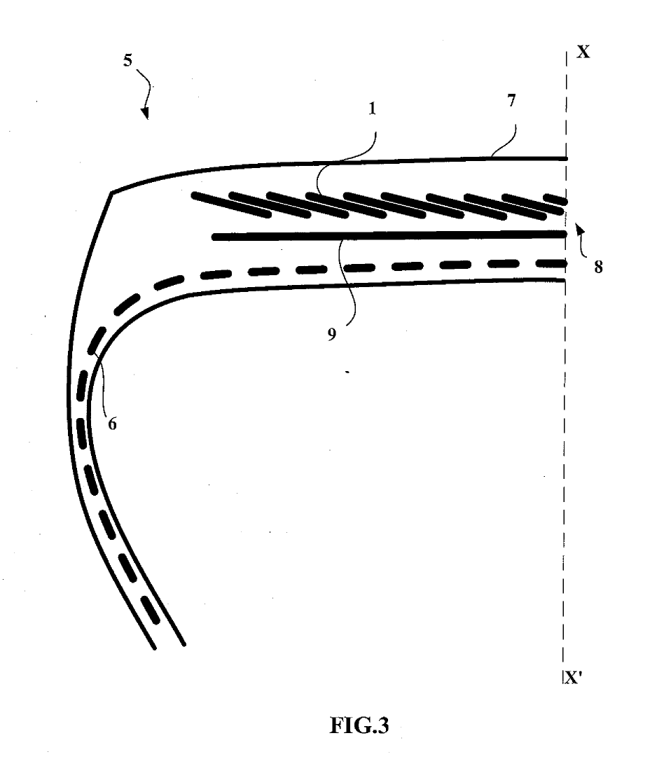

FIG. 3: a meridian view of a tire comprising the complex strip of FIG. 1.

To make them easier to understand, the figures are not drawn to scale. FIG. 3 depicts only a half-view of a tire which extends symmetrically with respect to the axis XX′ which represents the circumferential mid-plane, or equatorial plane, of a tire.

FIG. 1 depicts a diagram, with cutaway, of a complex strip 1 consisting of two layers 2, 3 of reinforcing elements 4 making an angle with the circumferential direction, parallel within one layer and crossed from one layer to the other with angles with respect to the circumferential direction that are identical in terms of absolute value.

The complex strip 1 is obtained according to a method which involves flattening a tube formed by winding in contiguous turns at a given angle with respect to the longitudinal direction of the tube, a tape in which reinforcing elements are parallel to one another and to the longitudinal direction of the said tape and coated in a polymer compound. When the tube is flattened, because the turns are perfectly contiguous, the complex strip obtained consists of two layers of continuous reinforcing elements passing from one layer to the other.

Producing a tube with contiguous turns makes it possible to obtain linear reinforcing elements 4 in each of the layers, with the exception of the axial ends of each of the layers where the reinforcing elements form loops to provide continuity from one layer to the next.

FIG. 2 corresponds to a meridian view of a schematic depiction of such a complex strip 1. This figure shows that the complex strip 1 consists of the two layers 2, 3 of reinforcing elements 4 in which the said reinforcing elements are continuous from one layer to the other.

The complex strip 1 thus depicted in the figures has the advantage of constituting a system of two layers of reinforcing elements that are parallel to one another and crossed from one layer to the next, the said layers not having any free ends of reinforcing elements.

The complex strip 1 is produced from a tape consisting of reinforcing elements having a diameter equal to 1.14 mm embedded in two liners 0.11 mm thick. Each of the layers thus has a thickness of 1.36 mm and the complex strip has a thickness of 2.72 mm, the radial distance between the respective reinforcing elements of each of the crown layers being equal to 0.22 mm. The radial distance between the respective reinforcing elements of each of the crown layers is equal to the sum of the thicknesses of the liner radially on the outside of the reinforcing elements of the radially inner layer and of the liner radially on the inside of the reinforcing elements of the radially outer layer.

FIG. 3 illustrates a tire 5 comprising a radial carcass reinforcement 6 anchored in two beads, not depicted in the figure, and capped by a tread strip 7. The carcass reinforcement 6 is also hooped by a crown reinforcement 8.

The reinforcement consists of a first layer of reinforcing elements 9; these may, for example, be a circumferential layer of reinforcing elements in the case of a tire for metro rolling stock.

The first layer 9 is radially covered by a complex strip 1 laid by circumferential winding. Winding is performed in this depiction in order to obtain an axial overlap of half the strip for each turn. The winding of the complex strip 1 thus forms four radially superposed layers of reinforcing elements that are parallel to one another within the same layer and crossed from one layer to the next without free ends.

According to other forms of embodiment, the turns formed during winding of the complex strip may be juxtaposed so that they form just two radially superposed layers of elements. The turns may also be axially overlapped by ⅔ of the width of the complex strip, at the time of winding, to form six superposed layers.

In the case of airplane tires, the crown reinforcement further usually comprises a protective layer consisting of metal reinforcing elements, the said layer being the radially outermost crown reinforcing layer.

Tests have been carried out with metro tires of size 345/85R16 produced according to the invention in accordance with the depiction of FIG. 3, and others with tires known as reference tires. The reference tires comprised just the layer of circumferential reinforcing elements 9.

The tests involved running to simulate the normal conditions of use in terms of speed and load.

These tests revealed that after a distance of the order of 300,000 km, the reference tires were exhibiting uneven wear, notably more pronounced at the shoulders, while the tread strip of the tires according to the invention showed uniform even wear after having covered the same number of kilometers.

Further, analysis of the tires according to the invention revealed no sign of premature ageing of the crown reinforcement or the surrounding polymer compounds, just as the nature of the complex strip could have predicted, this strip showing no free ends of the reinforcing elements.

Further tests were run with airplane tires of dimensions 46×17.0 R 20 and 1400×530 R 23. The tests involved comparing the traditional tires against tires according to the invention in terms of wear and endurance. By comparison with the reference tire, the tire according to the invention has a similar architecture in which the layers of reinforcing elements, produced by reeling, that is to say using techniques that involve laying reinforcing elements or tapes consisting of several reinforcing elements from one edge to the other continuously to form a period or a multiple of periods for one turn of the wheel, are replaced by complex strips so as to regain the same number of radially superposed layers.

The various tests carried out demonstrated that the tires according to the invention displayed results both in terms of wear and in terms of endurance that were entirely comparable with those obtained using the reference tires.

By contrast, the time taken to manufacture the tires according to the invention, and therefore their cost, can be markedly lower than those of the reference tires, the winding of a complex strip according to the invention being a far more rapid step in the manufacture of the tire than the step involving reeling an equivalent number of layers of reinforcing elements as described previously. The savings in terms of manufacturing time for an aircraft tire can be of the order of 60% in terms of the time taken to produce the crown reinforcement.

1. A tire comprising a crown reinforcement formed of at least two working crown layers of reinforcing elements, itself radially capped by a tread strip, said tread strip being connected to two beads via two sidewalls, wherein at least two working crown layers are formed by circumferential winding of a complex strip formed of two layers including continuous reinforcing elements passing from one layer to the other, said reinforcing elements being parallel within a layer and crossed from one layer to the other at angles with respect to the circumferential direction that are identical in terms of absolute value.

2. The tire according to claim 1, wherein the radial distance between the respective reinforcing elements of each of the crown layers forming a complex strip is less than the thickness of a crown layer.

3. The tire according to claim 1, wherein the reinforcing elements of the said complex strip make an angle of between 10 and 45° with the circumferential direction.

4. The tire according to claim 1, wherein the complex strip is wound circumferentially with an axial overlap.

5. The tire according to claim 1, wherein the complex strip is wound circumferentially to form juxtaposed turns.

6. The tire according to claim 1, wherein the reinforcing elements of the complex strip are made of metal.

7. The tire according to claim 6, wherein the reinforcing elements of at least one layer of circumferential reinforcing elements are metal reinforcing elements having a secant modulus at 0.7% elongation of between 10 and 120 GPa and a maximum tangent modulus of less than 150 GPa.

8. The tire according to claim 1, wherein the reinforcing elements of the complex strip are made of a textile material.

9. The tire according to claim 1, wherein the reinforcing elements of the complex strip are made of a hybrid material.

10. The tire according to claim 1, wherein the crown reinforcement comprises at least one layer of circumferential reinforcing elements.

11. The tire according to claim 1, wherein the crown reinforcement is supplemented radially on the outside by at least one supplementary layer, known as a protective layer, of reinforcing elements know as elastic elements, oriented with respect to the circumferential direction at an angle of between 10° and 45° and in the same direction as the angle formed by the inextensible elements of the working layer radially adjacent to it.

12. The tire according to claim 1, wherein the radial distance between the respective reinforcing elements of each of the crown layers forming a complex strip is less than half the thickness of a crown layer.

13. The tire according to claim 1, wherein the complex strip is wound circumferentially with an axial overlap, equal to at least half the width of said complex strip.
